(19) United States
(12) Patent Application Publication
(10) Pub. No.: US 2025/0004449 A1
(43) Pub. Date: Jan. 2, 2025

(54) METHOD FOR OPERATING MECHATRONIC FUNCTIONAL MODULES FOR THE PRODUCTION, PROCESSING, INSPECTION AND/OR TRANSPORT OF CONTAINERS, AND PRODUCTION SYSTEM HAVING THE FUNCTIONAL MODULES

(71) Applicant: KRONES AG, Neutraubling (DE)

(72) Inventors: Bernhard WESS, Neutraubling (DE); Elisabeth PILNEY, Neutraubling (DE); Ottmar AMANN, Hohenfels (DE); Thomas KELLHAMMER, Bach a.d. Donau (DE); Veronika TESAR, Bischofsmais (DE); Korbinian KASBERGER, Regensburg (DE); Florian FISCHER, Kelheim (DE); Andreas JEZIOROWSKI, Regensburg (DE)

(21) Appl. No.: 18/684,110

(22) PCT Filed: Jul. 14, 2022
(86) PCT No.: PCT/EP2022/069734

§ 371 Date: Feb. 15, 2024

(30) Foreign Application Priority Data
Aug. 17, 2021 (DE) 10 2021 121 306.1

(51) Int. Cl. G05B 19/418; B29C 49/78; B29L 31/00; B65B 3/00; B65B 57/00

(52) U.S. Cl. CPC G05B 19/41835; B29C 49/78; B65B 3/00; B65B 57/00; B29C 2049/78805; B29L 2031/712; G05B 2219/31001

(57) ABSTRACT

The invention relates to a method for operating mechatronic functional modules for the production, processing, inspection and/or intermodular transport of containers for liquid products in a production system, and to a corresponding production system. According to the invention, the functional modules each store, in machine-readable form, individually assigned initial design data and specification data and initial topological data at least regarding the product flow in the production system and the communication between the functional modules. Because the functional modules are also controlled using the initial design data, specification data and/or topological data, production processes and maintenance measures can be particularly flexibly carried out, in a decentralized way, with greater efficiency and with the possibility of intermodular data transfer.

### TECHNICAL FIELD

The invention relates to a method for operating mechatronic functional modules for the production, processing, inspection, and/or intermodular transport of containers for liquid products in a production system, and to a production system having such functional modules.

### BACKGROUND AND SUMMARY

Production systems—in particular, filling systems for filling beverages or similar liquid products in containers—are known to comprise a large number of mechatronic functional modules for the production, processing, inspection, and/or intermodular transportation of the containers. A specific production process is then assigned to each of the mechatronic functional modules, such as the stretch blow molding of plastic containers, the labeling of the containers, the filling of liquid products, or the transport between individual functional modules.

Such mechatronic functional modules are known to have electronic control devices, which on the one hand are used to control the runtime of the respective functional module, i.e., to control its operation with inclusion of the required actuators, sensors, frequency converters, or similar components. Furthermore, the control devices provide machine parameters and processing parameters of the corresponding functional module, e.g., for the type-specific working operation thereof and for the diagnosis of malfunctions, and also enable communication with central and/or decentralized control devices of the production system, and optionally with other functional modules.

One disadvantage is that the information required for maintenance work, such as circuit diagrams, parts lists, and design data, is not available in the region of the respective functional module, but usually has to be transferred from a central storage location. This is complicated, prone to errors, and can additionally be made difficult by communication requirements between the installation location and the storage location.

In addition, using their control devices, the functional modules can only be adapted relatively inflexibly to changed production conditions or optimized during operation, since only comparatively small amounts of data are available on-site, which essentially comprise only the functions and parameters of the respective functional module. In contrast, information on the production environment of the functional modules, i.e., on upstream or downstream functional modules and on the product flow in the respective production system, is generally missing. Such information then has to be retrieved from a central data source, which can be laborious.

There is therefore a need for methods for operating mechatronic functional modules and for production systems equipped therewith in which the effort for maintenance measures and/or type-specific production adjustments and the optimization of the production process in the interaction of the functional modules can be improved.

At least one of the objects mentioned above is achieved by a method and by a production system according to the present disclosure. Advantageous embodiments are specified in the dependent claims.

The method described is used to operate mechatronic functional modules for the production, processing, inspection, and/or intermodular transport of containers for liquid products—in particular, beverages—in a production system—in particular, filling system. For this purpose, in each case individually associated initial design data and specification data and initial topological data are stored in the functional modules in machine-readable form, wherein the topological data relate to at least the intermodular product flow in the production system and the communication between the functional modules. Furthermore, the functional modules are controlled with inclusion of the initial design data, specification data, and/or topological data.

The initial design and specification data stored in the corresponding functional module facilitate/enable maintenance of the corresponding functional module without requesting the relevant information from a central data source. The topological data stored in the functional module facilitate/enable, e.g., on the basis of the product flow then known, a production optimization with inclusion in particular of all functional modules involved in the product flow, i.e., taking into account their process-related interaction with one another. In addition, the communication required for this between the functional modules is facilitated by the locally/decentralized prespecified topological data in the functional module—in particular, by a direct intermodular connection setup on an initially specified communications path.

Mechatronic functional modules are understood to be machine units such as processing machines, processing assemblies, and/or inspection units comprised by them, which are each assigned a specific production process, such as preheating preforms, stretch blow molding or labeling containers, inspecting them, or the like.

Initial data are to be understood to mean those data which are already defined/specified as a result of the design, and possibly also in a product-specific manner, at the respective start of production. Initial data are stored in the functional modules, for example, when individual functional modules and/or the processing machines/production system comprising them are commissioned and/or are updated during associated maintenance measures.

A machine-readable data form is to be understood to mean that the described data in the functional modules are present in a standardized data format and/or can be read out by means of standardized communication protocols. For example, such that the initial design and specification data and the initial topological data can be read out and displayed by a mobile terminal device and/or by an operating and output unit on the functional module. On-site, this enables uncomplicated access to the information stored in the functional module.

For the independent connection setup of the functional modules among one another, the topological data comprise at least information relating to the identity and address of the functional modules, and in particular further information about which of the functional modules are in each case relevant and/or prioritized communication partners for one another. Communication can therefore be set up directly and automatically, without negotiating communication connections in the sense of an “online search” in the respective communications network, solely on the basis of the information stored in the functional modules. This facilitates the intermodular optimization of production processes, i.e., not only the optimization of the individual functional modules per se, but also their interaction in production operation.

Preferably, the initial design data, specification data, and topological data contain at least two of the following items of information: a 3-D CAD model of the functional module; a 3-D model for finite element simulation and/or simulation of frequency behavior in the functional module; an electrical circuit diagram of the functional module—in particular, with technical specifications of associated components; electrical connections of assemblies of the functional module; a P&I flow diagram of the associated processing machine and/or production system—in particular, with technical specifications of associated functional elements and their mutual dependencies; a layout plan of the associated processing machine and/or production system—in particular, with technical specifications of associated machine parts/system parts; parts lists of mechanical, electrical, pneumatic, and/or hydraulic components of the functional module; technical specifications of the containers to be processed with associated equipment objects, auxiliary materials, and/or filling products; maintenance documentation of the functional module, the associated processing machine, and/or production system; and specification of the life cycle of the functional module.

The control device/runtime system can thus be provided with comprehensive knowledge of initial design and specification data as well as topological data, i.e., essentially knowledge that originates from the upstream development process, the design and installation of the respective functional module, and/or the associated production system. This improves the decentralized and intermodular optimization of the production processes of the individual functional modules and also enables targeted and time-saving maintenance of the individual functional modules.

Preferably, at least a portion of the initial design and specification data and of the topological data are combined in a digital system model of the associated processing machine and/or production system, wherein the system model comprises at least four—in particular, all—of the function models involved in the product flow, and processes at least two of the following items of information: data points of sensors and actuators of the functional modules and of the associated data flow among them; catalog with mandatory and optional functions of the functional modules, and with mutual dependencies of their functional scopes; topology of the functional modules among one another and/or with respect to the associated processing machines and/or the production system; interface requirements of the functional modules; and requirements for supplying the functional modules with electrical energy, media, and consumables.

The system model preferably comprises all information necessary for intermodular communication. Identities and communication addresses defined in the system model can be transmitted to the respective functional modules and stored there. On the basis of the communication information from the system model stored decentrally in this way, a targeted connection setup and data exchange between functional modules assigned to each other as communication partners is possible automatically and directly, i.e., without negotiating network connections in each case.

The data points mentioned can be understood as data inputs or data outputs on sensors, actuators, frequency converters, controllers, or the like.

Comprehensive knowledge about the topology of the production system and the system model representing it can thus be transferred to the respective functional module, so that the individual functional modules can not only make local adjustments and optimizations, limited to the modules themselves, of the respective production process, but also support higher-level optimization goals, such as energy savings, quality optimization, or the like.

In the functional modules, it is also possible to store and/or process individually associated current status data of the functional modules, wherein the functional modules are then controlled with inclusion of the current status data. These then contain at least two of the following items of information: current operating state, current operating mode, and/or current disturbances of the functional module; operator information and/or operator instructions; current forecasts of material requirements and/or maintenance times; current recommendations for action for the production process; current software version data; current diagnostic data; current power and/or consumption data, such as, for example, current power and media consumption and/or efficiency.

This allows the initial knowledge from the upstream development and design processes to be combined and/or compared with current knowledge from running operation in order to be able, for example, to carry out maintenance measures and/or production optimizations in a particularly targeted manner.

Furthermore, individually associated historical data of the functional module can be stored and/or processed in the functional modules, wherein the functional modules are then controlled with inclusion of the historical data. These then contain at least two of the following items of information collected over several production processes; electronic logbook of the functional module; AI training parameter sets; AI learning results; limit values of machine parameters and associated operating states; switching cycles; load changes; temperature curves; communication utilization; AI experiential knowledge from interactions with operators; cause-error correlations; long-term data on energy and media consumption and/or efficiency.

This means that data collected over several production batches and/or data obtained from self-learning processes, i.e., data obtained on the basis of AI (artificial intelligence), can also be included in the respective adaptation and optimization tasks decentrally at the respective functional module.

The functional modules can configure, diagnose, organize, optimize, protect, and/or heal themselves automatically on the basis of the individually assigned initial design and specification data as well as the topological data.

Self-configuration means that data knowledge about itself and about autonomous changes is stored in the functional module, and on this basis, for example, it is possible to switch from a basic configuration to particular production configurations, or between such configurations, automatically.

A self-diagnosis is to be understood as meaning that data knowledge about itself is stored in the functional module and, on this basis, its operating state is researched and/or calculated and can be explained independently. In particular, the module can then independently create and/or select proposed solutions.

Self-organization refers to an intramodular combination of self-configuration and self-diagnosis, resulting in the adaptation of process and/or program sequences—in particular, automatically, in conjunction with other functional modules.

Self-optimization can also be understood as an intramodular combination of self-configuration and self-diagnosis, which results in an independent adaptation of the configuration for process optimization.

Self-protection can likewise be understood to mean an intramodular combination of self-configuration and self-diagnosis, with the result that protective measures are automatically initiated by the functional module—for example, against foreseeable fault states.

Self-healing is to be understood to mean that, for example, self-diagnosis and self-configuration are combined with one another in an intramodular manner in such a way that repair measures—in particular, of non-foreseeable fault states—can be initiated and/or carried out independently by the corresponding functional module.

The functional module obtains the knowledge about itself required for this, for example, from the initial design and specification data, e.g., on the basis of requirements, limitations, intermodular dependencies, the higher-level configuration of the processing machine and/or production system comprising the functional module, on the basis of target values, target loads, descriptions encompassing multiple modules, performance data, tolerances, service life data, logbook data, or the like.

In this way, both adaptations and optimizations of the respective functional modules and of the processing machine and/or production system as a whole can be flexibly carried out in conjunction with one another for different operating conditions and production requirements.

The production system described is in particular a filling system and comprises mechatronic functional modules for the production, processing, inspection, and/or intermodular transport of containers for liquid products—in particular, beverages—i.e., for transporting between the individual functional modules. The functional modules each comprise: a storage device with initial design and specification data of the functional module, stored therein in each case in a machine-readable manner, and with topological data relating at least to the product flow in the production system and the communication between the functional modules. Furthermore, the functional modules each comprise a control device for the runtime control of the functional module, including the design data, specification data, and/or topological data—in particular, according to the method according to at least one of the described embodiments.

The advantages described with respect to claim 1 can be achieved in this way.

The functional modules can comprise at least two of the following module types: heating module for heating preforms or containers; stretch blow molding module for shaping the containers; cooling module for cooling the containers; turning module for turning the containers upside down; coating module for coating the inside of the containers; printing module for printing on the containers; labeling module for labeling the containers; inspection module for inspecting the containers; cleaning module for cleaning the containers; filling module for filling the liquid products into the containers; and/or sealing module for sealing the filled containers.

The functional modules can further comprise at least one of the following module types: conveyor belt—in particular, with slaves for receiving containers; linear motor transport system; transport carousel—in particular, with container clamps; and environmental transport section.

The different types of modules mentioned can be controlled and maintained in a particularly effective and efficient manner in the production system using the methods described.

The control device can comprise an electronic processing unit—in particular, with internet-of-things functionality—which is programmed to process the initial design and specification data of the functional module and topological data and in particular of individually associated current status data of the functional module and/or individually associated historical data of the functional module. The processing unit is then for example connected to an API (application programming interface), which can for example communicate with individual functional modules, establishes connection to a cloud, establishes the connection to a human-machine interface, and/or establishes the connection to an electronic sales platform and/or an analysis service.

The production system preferably comprises a communications network for the functional modules in such a way that these are set up for the decentralized provision of initially defined identities and addresses of all functional modules provided as communication partners as a part of the topological data, and furthermore for the independent setup of communication among one another on the basis of the identities and addresses defined in this way.

The control device can comprise a processing unit which is programmed with a digital system model of the associated processing machine and/or production system, in which at least a part of the initial design and specification data, of the topological data, and at least two of the following items of information are processed, in each case relating to at least four—in particular, all—of the functional models involved in the product flow: data points of sensors and actuators of the functional modules as well as the associated data flows among them; catalog with mandatory and optional functions of the functional modules and with mutual dependencies of their functional scopes; topology of the functional modules among each other and relating to the processing machines and/or production system comprising them; interface requirements of the functional modules; and requirements for supplying the functional modules with electrical energy, media, and consumables.

### BRIEF DESCRIPTION OF THE FIGURES

A preferred embodiment of the invention is illustrated in the drawing. In the figures:

FIG. 1 shows a schematic illustration of a production system with functional modules;

FIG. 2 shows the diagram of a system model with functional modules; and

FIG. 3 shows a schematic illustration of a control device of a functional module.

### DETAILED DESCRIPTION

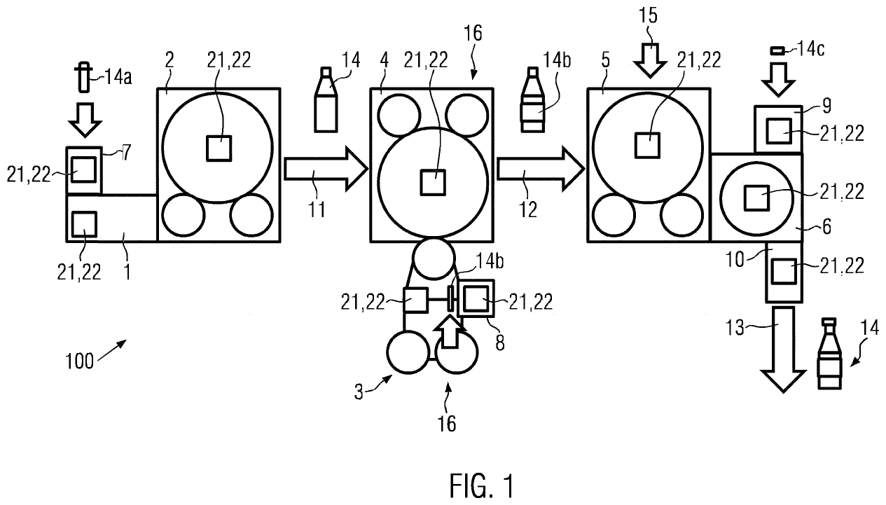

As can be seen in FIG. 1, the described production system 100, which in the example shown is a filling system, comprises mechatronic functional modules 1 to 13 for the production, processing, and/or intermodular transport of containers 14 for liquid products 15, which are in particular beverages. The containers 14 are accordingly stretch blow molded from preforms 14a, equipped with labels 14b, filled with the liquid product 15, and sealed with caps 14c.

Accordingly, a first functional module 1 is used for preheating the preforms 14a, and a second functional module 2 is used for stretch blow molding the containers 14 from the preforms 14a and thus for producing the containers 14 in each case. Furthermore, a third and fourth processing module 3, 4 are used for labeling the containers 14 with the labels 14b, a fifth functional module 5 is used to fill the liquid product 15 into the containers 14, and a sixth functional module 6 is used to close the filled containers 14 with the caps 14c, and thus, in the sense of the present invention, these are each used in the processing of the containers 14.

A seventh functional module 7 is used to inspect the preforms 14a, an eighth functional module 8 is used to inspect the labels 14b, a ninth functional module 9 is used to inspect the caps 14c, and a tenth functional module 10 is used to inspect the filled and closed containers 14, and thus, in the sense of the present invention, in each case these are used to inspect the containers 14.

Also shown schematically are functional modules 11 to 13 for intermodular transport of the containers 14 in the production system 100, i.e., to/from/between the functional modules 1 to 10.

As shown in FIG. 1, the functional modules 1 to 13 can be processing machines, processing aggregates, inspection units, and/or transport paths for the containers 14. For example, the third functional module 3 in the form of a labeling unit and the fourth functional module 4 in the form of a container carousel can be assigned to each other and together form a processing machine 16—in the example shown, a labeling machine.

The production system 100 shown is merely an example with regard to the number and types of functional modules 1 to 13. In principle, the production system 100 could comprise at least two of the following module types: heating module for heating preforms 14a or containers 14; stretch blow molding module for shaping the containers 14; cooling module for cooling the containers 14; turning module for turning the containers 14 upside down; coating module for coating the inside of the containers 14; printing module for printing on the containers 14; labeling module for labeling the containers 14; inspection module for inspecting the containers 14; cleaning module for cleaning the containers 14; filling module for filling the liquid products 15 into the containers 14; and/or sealing module for sealing the filled containers 14.

The functional modules can also be of the following module types: conveyor belt—in particular, with slaves for receiving the containers 14; linear transport system for transporting the containers 14; transport carousel—in particular, with container clamps for transporting the containers 14; and/or bypass transport section for the containers 14 for bypassing individual production processes/functional modules.

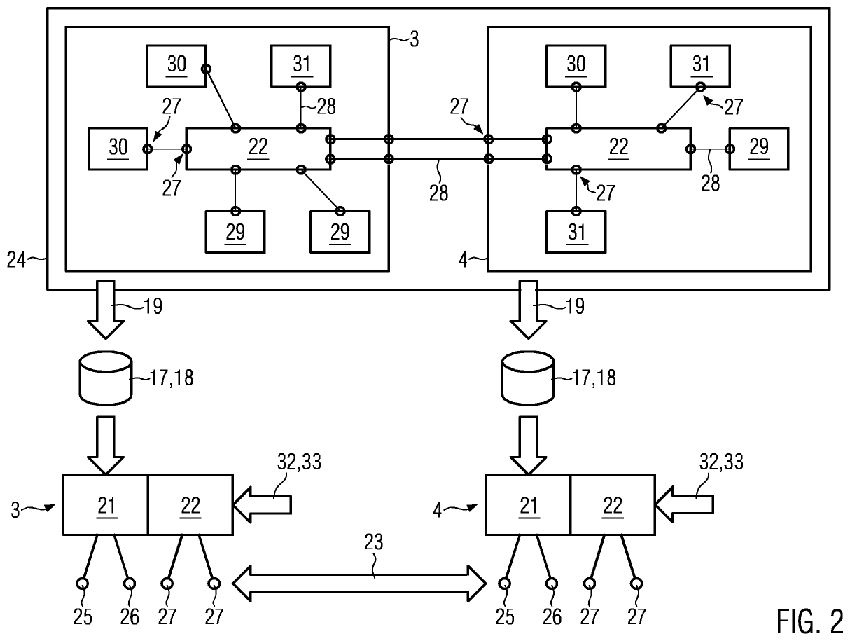

FIG. 2 schematically illustrates the principle underlying the present invention of storage and processing, in each case decentralized with respect to the production system 100/processing machine 16, of initial design data 17, initial specification data 18 of the functional modules 3, 4 shown here as examples and of topological data 19 at least relating to the product flow in the production system 100, and the intermodular communication in the respective functional modules 3, 4.

For this purpose, the functional modules 3, 4 each comprise a storage device 21 with the initial design data 17, the initial specification data 18, and the topological data 19 stored therein in machine-readable form. Furthermore, the functional modules 3, 4 each comprise an electronic control device 22 for runtime control of the corresponding functional module 3, 4, including the design data 17, specification data 18, and/or topological data 19 stored therein. This is indicated in FIG. 1 by way of example only for the functional modules 1 to 10.

The topological data 19 enable the functional modules 3, 4 to set up an independent connection 23 with each other and include all the necessary information on the functional modules 3, 4 that communicate with each other. The topological data 19 preferably further comprise information about which of the functional modules 1 to 13 of the production system 100 are relevant and/or prioritized communication partners for one another. In the example of FIG. 2, this applies for example to the functional modules 3, 4 that interact directly in the processing machine 16 in terms of the process.

For the independent connection setup 23, all the information required for this is combined in a system model 24 of the associated processing machine 16 and/or the production system 100, and is defined in advance for all participating functional modules 1 to 13 in such a way that the communication setup no longer has to be negotiated by the functional modules 3, 4 in the sense of an online search in a network. For this purpose, for example, both the identity 25 and the address 26 of the fourth functional module 4 are stored in the third functional module 3, and vice versa. The same applies to all functional modules 1 to 13 which communicate with one another.

Likewise, information relating to data points 27, which relates to the data flow 28 between actuators 29, sensors 30, frequency converters 31, control devices 22, or similar data sources or data receivers, is stored in the functional modules 3, 4 in a decentralized manner. The corresponding data points 27/the data flow 28 are also defined in the system model 24.

This means that the information required for the communication setup 23 and the data flow 28 can be transferred from the system model 24 to all participating functional modules 1 to 13 in advance and stored there.

The system model 24 thus acts as a common data basis with which the functional modules 1 to 13 are provided both with information about their own functions, requirements, and scope of performance and with corresponding information about other functional modules 1 to 13 with which there is interaction during the production process.

In addition, in each case individually associated current status data 32 of the functional modules 1 to 13 can be stored and processed in the functional modules 1 to 13, in order to also control the functional modules 1 to 13 on the basis of the current status data 32.

It is also conceivable to additionally store and process individually associated historical data 33 of the functional modules 1 to 13 in the functional modules 1 to 13 in order to then also control the functional modules 1 to 13 on the basis of historical data 32 collected from several production processes/batches.

A corresponding data flow 28 is also possible on the basis of the described communication setup 23 between the individual functional modules 1 to 13, but also within the individual functional modules 1 to 13, likewise on the basis of the system model 24.

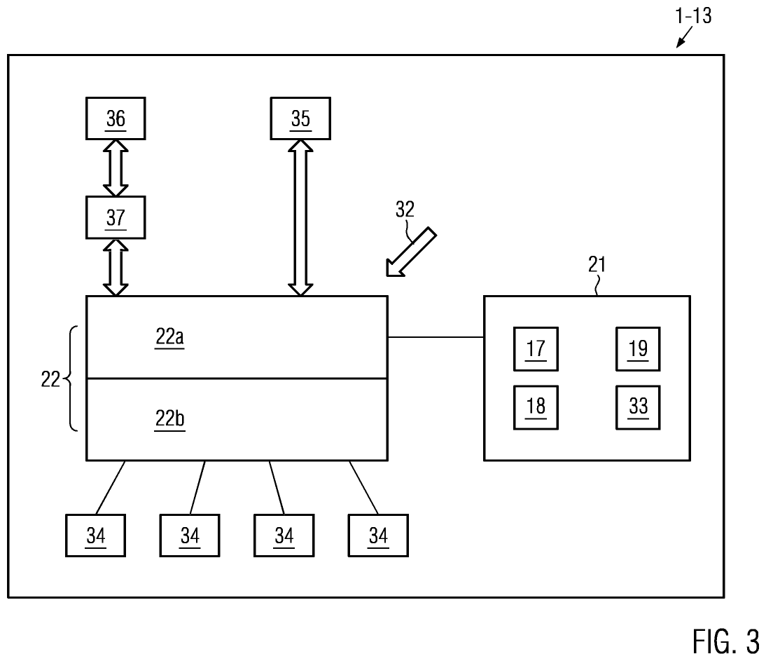

FIG. 3 schematically shows an example of the decentralized control in the functional modules 1 to 13. Accordingly, the control device 22 of the respective functional module 1 to 13 can comprise a processing unit 22a with internet-of-things functionality and an application programming interface 22b with which, for example, functions of individual functional modules 1 to 13 can be called up, and data can be read and written.

It is also possible to connect the individual modules 1 to 13 to external data processing modules 34, such as a cloud, an e-shop, a human-machine interface, a fault analysis service, or the like.

For this purpose, the initial design and specification data 17, 18 and the described topological data 19 are provided to the respective control device 22, and, if necessary, also the current status data 32 and the historical data 33. The internet-of-things component 22a can then, for example, cooperate with manufacturer applications 35 and/or user applications 36—possibly via intermediate drivers 37—in a manner known in principle.

On the basis of the initial design and specification data 17, 18 and the in particular initial topological data 19, self-sufficient module functions of the following types can be implemented in the functional modules 1 to 13, if necessary including the current status data 32 and/or the historical data 33: self-configuration; self-diagnosis; self-organization; self-optimization; self-protection and/or self-healing.

That is, in the manner described, the functional modules 1 to 13 are preferably provided with so much knowledge about themselves in the sense of a functional identity, a functional scope, and the relevant interactions with other functional modules 1 to 13 that a machine self-awareness and the property of machine self-modification arise, which can then result in the capacity for self-configuration of the respective functional module 1 to 13.

The described decentralized control and the associated decentralized communication setup among the functional modules 1 to 13 not only enable the autonomous maintenance and optimization of production processes on the individual functional modules 1 to 13 considered in themselves, but also the complex optimization of the production process in the interaction with each other of the production processes running in the functional modules 1 to 13.

That is, the individual functional modules 1 to 13 preferably know all their functionally relevant components and communication partners, i.e., all relevant functional modules 1 to 13 and/or processing machines 16 of the production system 100, and also the product flow through the production system 100—preferably from the common system model 24—and can make independent adjustments on this basis, e.g., to reduce energy consumption, to react to changed operating conditions in other functional modules 1 to 13 of the production system 100, for quality assurance, for material supply, for adjusting maintenance cycles, cleaning cycles, the production process, or the like.

Such adjustments are made during the runtime control of the production process in the production system 100 by the individual control devices 22 of the functional modules 1 to 13 in the sense that all the information required for this in the form of machine-readable data 17, 18, 19 can be processed decentrally in the respective functional modules 1 to 13—for example, by including current status data 32 of the participating functional modules 1 to 13.

1. Method for operating mechatronic functional modules for production, processing, inspection, and/or intermodular transport of containers for liquid products in a production system wherein in each case individually assigned initial design and specification data and initial topological data at least regarding a product flow in the production system and a communication between the functional modules are stored in the functional modules in machine-readable form, and wherein the functional modules are controlled with an inclusion of the initial design data, specification data, and/or topological data.

2. Method according to claim 1, wherein the topological data for an independent connection setup of the functional modules among one another comprise at least information relating to their identity and address, and further information about which of the functional modules are in each case relevant and/or prioritized communication partners for one another.

3. Method according to claim 1, wherein the initial design and specification data contain at least two of the following items of information: a 3-D CAD model of the functional module; a 3-D model for finite element simulation and/or simulation of frequency behavior in the functional module; an electrical circuit diagram of the functional module and technical specifications of associated components; electrical connections of assemblies of the functional module; a P&I flow diagram of the associated processing machine and/or production system and technical specifications of associated functional elements and their mutual dependencies; a layout plan of the associated processing machine and/or production system and technical specifications of associated machine parts/system parts; parts lists of mechanical, electrical, pneumatic, and/or hydraulic components of the functional module; technical specifications of the containers to be processed with associated equipment objects, auxiliary materials, and/or filling products; maintenance documentation of the functional module, the associated processing machine, and/or production system; and specification of a life cycle of the functional module.

4. Method according to claim 3, wherein at least a portion of the initial design and specification data and of the topological data are combined in a digital system model of the associated processing machine and/or production system, wherein the system model comprises at least four—in particular, all—of the functional models involved in the product flow, and processes at least two of the following items of information: data points of sensors and actuators of the functional modules and of the associated data flow among them; catalog with mandatory and optional functions of the functional modules, and with mutual dependencies of their functional scopes; topology of the functional modules among one another and with respect to the associated processing machines and/or the production system; interface requirements of the functional modules; and requirements for supplying the functional modules with electrical energy, media, and consumables.

5. Method according to claim 3, wherein, in the functional modules, in addition, current status data individually associated with the functional modules are stored and/or processed, wherein the functional modules are controlled using the current status data, and wherein these data contain at least two of the following items of information: current operating status, current operating mode, and/or current disturbances of the functional module; operator instructions and/or operator tasks; current forecasts of material requirements and/or maintenance times; current recommendations for action for production control; current software version data; current diagnostic data; current application data—in particular, current energy and media consumption and/or efficiency.

6. Method according to claim 3, wherein the functional modules furthermore contain and/or process individually associated historical data of the functional modules, wherein the functional modules are controlled with inclusion of the historical data, and wherein these data contain at least two of the following pieces of information: electronic logbook of the functional module; AI training parameter sets; AI learning results; limit values of machine parameters and associated operating states; switching cycles; load changes; temperature curves; communication utilization; AI experiential knowledge from interactions with operators; cause-fault correlations; long-term data on energy and media consumption and/or efficiency.

7. Method according to claim 4, wherein the functional modules each independently configure, diagnose, organize, optimize, protect, and/or heal themselves in terms of control technology on the basis of the individually associated initial design and specification data and the topological data.

8. Production system having mechatronic functional modules for the production, processing, inspection, and/or intermodular transport of containers for liquid products wherein the functional modules each comprise: a memory device with initial design and specification data of the functional module and topological data, stored therein in each case in a machine-readable manner, at least relating to the product flow in the production system and the communication between the functional modules; and a control device for runtime control of the functional module with inclusion of the design data, specification data, and/or topological data—to the method according to claim 7.

9. Production system according to claim 8, wherein the functional modules comprise at least two of the following module types: heating module for heating preforms or containers; stretch blow molding module for shaping the containers; cooling module for cooling the containers; turning module for turning the containers upside down; coating module for coating an inside of the containers; printing module for printing on the containers; labeling module for labeling the containers; inspection module for inspecting the containers; cleaning module for cleaning the containers; filling module for filling the liquid products into the containers; and/or sealing module for sealing the filled containers.

10. Production system according to claim 9, wherein the functional modules further comprise at least one of the following module types: conveyor belt; linear motor transport system; transport carousel; and bypass transport section.

11. Production system according to claim 8, wherein the control device comprises a processing unit which is programmed to process the initial design and specification data of the functional module and topological data and of individually associated current status data of the functional module and/or individually associated historical data of the functional module.

12. Production system according to claim 8, wherein the functional modules are set up for decentralized storage of initially defined identities and addresses of all functional modules provided as communication partners as a component of the topological data and in addition for the independent communication setup among one another on the basis of the identities and network addresses defined in this way.

13. Production system according to claim 8, wherein the control device comprises a processing unit which is programmed with a digital system model of the associated processing machine and/or production system, in which at least a part of the initial design and specification data, of the topological data, and at least two of the following items of information are processed in each case relating to at least four of the functional models involved in the product flow: data points of sensors and actuators of the functional modules as well as the associated data flows among them; catalog with mandatory and optional functions of the functional modules and with mutual dependencies of their functional scopes; topology of the functional modules and the associated processing machines and/or production system; interface requirements of the functional modules; and requirements for supplying the functional modules with electrical energy, media, and consumables.

14. Method according to claim 1, wherein the liquid products are beverages and the production system is a filling system.

15. Method according to claim 4, wherein the system model comprises all of the functional models involved in the product flow.

16. Method according to claim 5, wherein the current application data is current energy and media consumption and/or efficiency.

17. Production system according to claim 8, wherein the production system is a filling system and the liquid products are beverages.

18. Production system according to claim 10, wherein the conveyor belt has slaves for receiving containers and/or the transport carousel has container clamps.

19. Production system according to claim 11, wherein the processing unit has internet-of-things functionality.

20. Production system according to claim 13, wherein the items of information processed in each case relate to all of the functional models involved in the product flow.
